(19) United States
(12) Patent Application Publication
(10) Pub. No.: US 2004/0062300 A1
(43) Pub. Date: Apr. 1, 2004

(54) System and method for detecting direct sequence spread spectrum signals using batch processing of independent parameters

(76) Inventors: John G. McDonough, La Jolla, CA (US); Gibong Jeong, San Diego, CA (US); Karim Abdulla, San Diego, CA (US); Rajiv R. Nambiar, San Diego, CA (US); William S. Clark JR., Escondido, CA (US)

Correspondence Address: TEXAS INSTRUMENTS INCORPORATED, P O BOX 655474, M/S 3999, DALLAS, TX, 75265

(21) Appl. No.: 10/659,905

(22) Filed: Sep. 11, 2003

Related U.S. Application Data
(60) Provisional application No. 60/415,213, filed on Oct. 1, 2002.

(51) Int. Cl. H04B 1/707

(52) U.S. Cl. 375/150

(57) ABSTRACT

System and method for efficient detecting of direct sequence spread spectrum signals using a searcher with batched processing. A preferred embodiment comprises a controller (such as the MCU 310) that writes sets of search parameters to a memory (such as the memory 315) to specify a group of hypotheses. A searcher (such as the searcher 305) reads the sets of search parameters from the memory and generates the groups of hypotheses from the sets of search parameters. The searcher then assigns the hypotheses to correlators and tests each of the hypotheses. Results from the testing can be written back to the memory.

This application claims the benefit of U.S. Provisional Application No. 60/415213, filed on Oct. 1, 2002, entitled Method and Apparatus for Detecting DS SS Signals Using Batch Processing of Independent Parameters, which application is hereby incorporated herein by reference.

### CROSS-REFERENCE TO RELATED APPLICATIONS

This application is related to the following co-pending and commonly assigned patent applications: Ser. No. 10/651,120, filed Aug. 28, 2003, entitled “System and Method for Detecting Direct Sequence Spread Spectrum Signals Using Pipelined Vector Processing”; Ser. No. 10/651,282, filed Aug. 28, 2003, entitled “System and Method for Detecting Multiple Direct Sequence Spread Spectrum Signals Using a Multi-Mode Searcher”; Ser. No. 10,439,400, filed May 16, 2003, entitled “System and Method for Intelligent Processing of Results from Search of Direct Sequence Spread Spectrum (DSSS) Signals”; Ser. No. 10/650,427, filed Aug. 28, 2003, entitled “System and Method for Performing Symbol Boundary-Aligned Search of Direct Sequence Spread Spectrum Signals”, which applications are hereby incorporated herein by reference.

### TECHNICAL FIELD

The present invention relates generally to a system and method for digital wireless communications, and more particularly to a system and method for efficiently detecting direct sequence spread spectrum signals using batched processing.

### BACKGROUND

In many modern digital wireless communications systems, for example, communications systems based upon third-generation code-division multiple access (CDMA) techniques such as CDMA2000 (also known as IS-2000) and UMTS WCDMA (Universal Mobile Telephony System Wideband-CDMA, or simply UMTS), base stations (also known as cell sites) or even sectors within a base station's coverage area may use different timing offsets of scrambling codes to differentiate between the different base stations or sectors. In a CDMA system, part of the process of establishing a communications link between a mobile station and a base station (or sector) is to have the mobile station search for a base station and to determine a frame offset (also known as frame synchronization offset) for the base station. This process of searching for a base station and determining the frame offset is commonly referred to as synchronization or acquisition. In UMTS systems, the mobile station has to further determine a downlink scrambling code used by the base station (or sector). This is due to the fact that in a UMTS compliant system, each base station uses a different scrambling code.

To achieve synchronization with a base station, the mobile station may use what is known as a searcher unit to perform an initial base station acquisition, base station measurement, delay profile estimation, and so forth. The mobile station can begin by first acquiring the scrambling code, code offset, and carrier frequency of the strongest base station (typically the base station closest to the mobile station). The mobile station can then measure the link quality of the radio links of neighboring base stations to be used in the support of various forms of handoff. Then the mobile station can estimate the delay profile in order to perform an allocation of rake receiver fingers or demodulator elements. The role of the searcher unit can be described as testing a hypothesis that a spread spectrum signal (for example, a pilot channel from a base station) exists at a particular code offset and/or at a certain carrier frequency and/or with a certain scrambling code.

The time to synchronization is one of the more critical performance metrics of a mobile station at power-up. Therefore, to provide a small synchronization time, a searcher with high throughput is required. Furthermore, the mobile station may need to measure a large number of neighboring base stations (for use in handoffs). Additionally, an existing radio link's multipath profile may need to be monitored so that rake receiver fingers can be assigned to strong multipath components with little or no latency to ensure the maximization of the received signal. To further complicate the high throughput requirement, parameters of the search being performed may be different from one base station to another. For example, search parameters may include but are not limited to hypotheses, pilot channel types, coherent dwell time, noncoherent dwell time, search window size, search resolution, and so forth.

A prior art design for a searcher unit correlates I and Q samples from a received signal with a locally stored scrambling code in serial fashion wherein one hypothesis is tested at a time. The prior art design features a simple correlator that is easy to create and can operate at very high frequencies, offsetting its sequential operation.

Another prior art design for a searcher unit uses a parallel design wherein multiple hypotheses (code offsets) are tested simultaneously. The parallel design permits the testing of multiple hypotheses at one time, hence increasing the total number of hypotheses that can be tested for a given period of time. The parallel design can make use of a simple correlator design, permitting high frequency operation.

One disadvantage of the prior art is that the prior art designs require high operating frequencies to ensure that sufficient numbers of hypotheses can be tested within an allotted amount of time. The high frequency operation may require that the searcher units, specifically, the correlators, be created from more expensive fabrication technologies. This may possibly lead to a more expensive mobile station. Furthermore, the high frequency operation may result in greater power consumption, which can lead to shorter battery life for the mobile station.

A second disadvantage of the prior art is that the use of a serial searcher design may involve the use of a significant amount of software control for the processing of intermediate results. This can increase the complexity of the searcher design and require additional computational power from a processing unit. The additional computational power may lead to more power consumption and a more expensive mobile device (due to the more expensive processing unit). The additional complexity in the software can lead to decreased reliability.

A third disadvantage of the prior art is that the parallel design for the searcher unit may impose certain restrictions on the use of the correlator. For example, the parallel correlators must start and stop operation in synchrony. Additionally, the code offsets being tested may need to be contiguous due to the use of a serial code generator that uses linear shift registers. The requirement that the code offsets be contiguous can restrict the amount of pseudo-random number (PN) space searched, as the hypotheses provided to the searcher unit must be contiguous in PN space. Since the code offsets need to be contiguous, the hypotheses may be referred to as being dependent hypotheses. The restrictions on the parallel correlators may also reduce the utilization of the correlators since independent hypotheses cannot be tested at the same time.

A fourth disadvantage of the prior art is that when there are many searches of varying parameters need to be performed, it is typical for a processor of the mobile station to have significant interaction with the searcher. For example, the processor may have to program the searcher to perform a search and then when the search is complete, the processor must program a new search. This high degree of interaction can keep the processor from being able to perform its other required tasks in a timely manner.

### SUMMARY OF THE INVENTION

These and other problems are generally solved or circumvented, and technical advantages are generally achieved, by preferred embodiments of the present invention which provides a system and method for increasing the search capabilities of a search via the use of batched processing.

In accordance with a preferred embodiment of the present invention, a method for detecting signals comprising reading a set of search parameters, generating a group of hypotheses from the set of search parameters, assigning each hypothesis from the group to a correlator, correlating a pseudo-random number (PN) sequence generated from each hypothesis against a received sequence, accumulating the correlation result, and processing the accumulation result

In accordance with another preferred embodiment of the present invention, a circuit comprising a memory to store sets of search parameters and search results, wherein each set of search parameters is assigned a reference number, and a set of search results for a set of search parameters is stored with the same reference number, a searcher coupled to the memory, the searcher containing circuitry to read a set of search parameters from the memory, process pseudo-random number (PN) sequences generated based the set of search parameters with a received sequence, and write the correlation results to a set of search results with the reference number of the set of search parameters, and a sequence generator coupled to the searcher, the sequence generator containing circuitry to generate a PN sequence from each hypothesis provided to it by the searcher

In accordance with another preferred embodiment of the present invention, a wireless device comprising an analog front end coupled to an antenna, the analog front end containing circuitry to filter and amplify a received signal provided by the antenna, an analog-to-digital converter (ADC), the ADC to convert an analog signal provided by the analog front end into a digital symbol stream, and a processing unit coupled to the ADC, the processing unit containing circuitry to store sets of search parameters and search results, test hypotheses derived from the sets of search parameters

An advantage of a preferred embodiment of the present invention is that processing overhead on a mobile station's processor can be reduced by allowing the processor to specify a plurality of searches at one time and not having to specify a new search immediately after a previous search completes. Therefore, the number of times that the processor may need to be interrupted can be reduced.

A further advantage of a preferred embodiment of the present invention is that a searcher with a plurality of correlators may have increased utilization of its correlators since more than one search can be executing at one time. Hence, searcher throughput can be increased.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a figure of an exemplary wireless communications system;

FIG. 2 is a diagram of a portion of a wireless device with a prior art searcher;

FIG. 3 is a diagram of a portion of a wireless device with a searcher capable of using batched processing to improve searcher throughput, according to a preferred embodiment of the present invention;

FIG. 4 is a diagram of a searcher and attendant hardware, wherein the searcher uses batched processing to improve searcher throughput, according to a preferred embodiment of the present invention;

FIG. 5 is a diagram of an algorithm used for writing sets of search parameters to record memory, according to a preferred embodiment of the present invention;

FIG. 6 is a diagram of an algorithm used for using sets of search parameters to test hypotheses via batch processing, according to a preferred embodiment of the present invention; and

FIG. 7 is a diagram of a wireless device with a searcher using batched processing of independent parameters to improve searcher throughput, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a digital wireless communications network that may be compliant to the CDMA (IS-95), CDMA2000, and the UMTS (Universal Mobile Telecommunications System) technical standards. An overview of the CDMA2000 technical standard is provided in a document entitled “Introduction to CDMA2000 Spread Spectrum Systems, Release 0,” which is herein incorporated by reference. An overview of the UMTS technical standard is provided in a document entitled “3^{rd} Generation Partnership Project; Technical Specifications Group Services and System Aspects General UMTS Architecture (Release 4),” which is herein incorporated by reference. The invention may also be applied, however, to other digital wireless communications systems which uses specific coded signals to identify base stations and which require that mobile station acquire these coded signals prior to initializing communications.

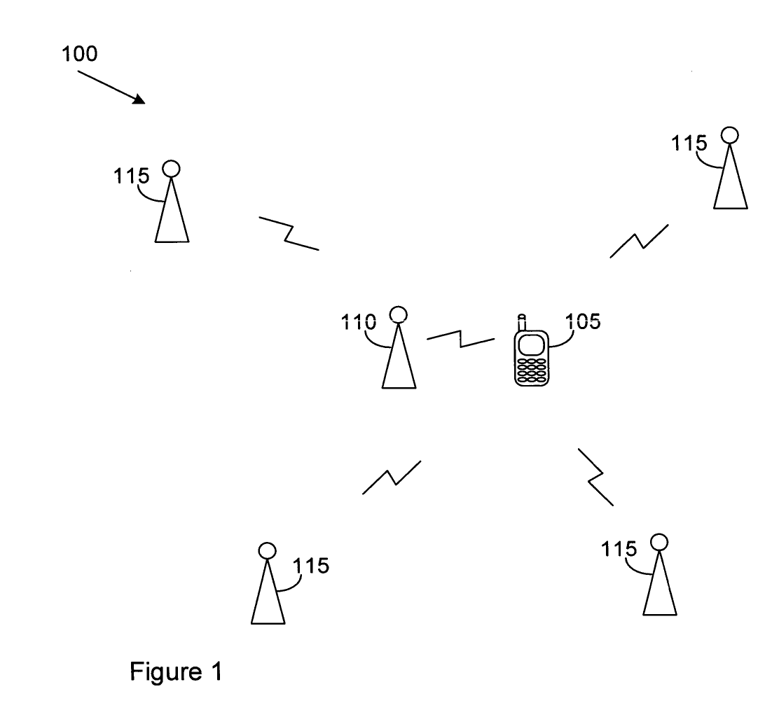

With reference now to FIG. 1, there is shown a diagram illustrating an exemplary wireless communications system 100. In the wireless communications system, there may be a mobile station 105 that is communicating with a base station 110. In addition to the base station 110, there may be a plurality of other base stations 115, which may be further away from the mobile station 105 than the base station 110. The mobile station 105, upon power-up, was able to synchronize with a signal from the base station 110 and hence began using the base station 110 to connect to the wireless communications system 100.

As discussed previously, in a code-division multiple access (CDMA) wireless communications system, such as an IS-95, CDMD2000, or UMTS compliant system, a mobile station is required to become synchronized with a base station upon power-up. The synchronization process requires that the mobile station perform a plurality of correlations of various offsets of a locally stored pseudo-random number (PN) sequence with a received signal. The correlation may also involve the application of various scrambling codes. Furthermore, the mobile station may be required to test received signals at various carrier frequencies.

The synchronization of the mobile station to a base station is normally performed in a portion of the mobile station commonly referred to as a searcher. The searcher receives as input, the received signals detected by the mobile station, usually in the form of a pair of sequences, I and Q. The searcher then correlates the I and Q sequences with a locally stored PN sequence set at a particular offset. The offset is commonly referred to as a PN offset and the process of correlating the received sequences with the PN sequence is commonly referred to as testing a hypothesis.

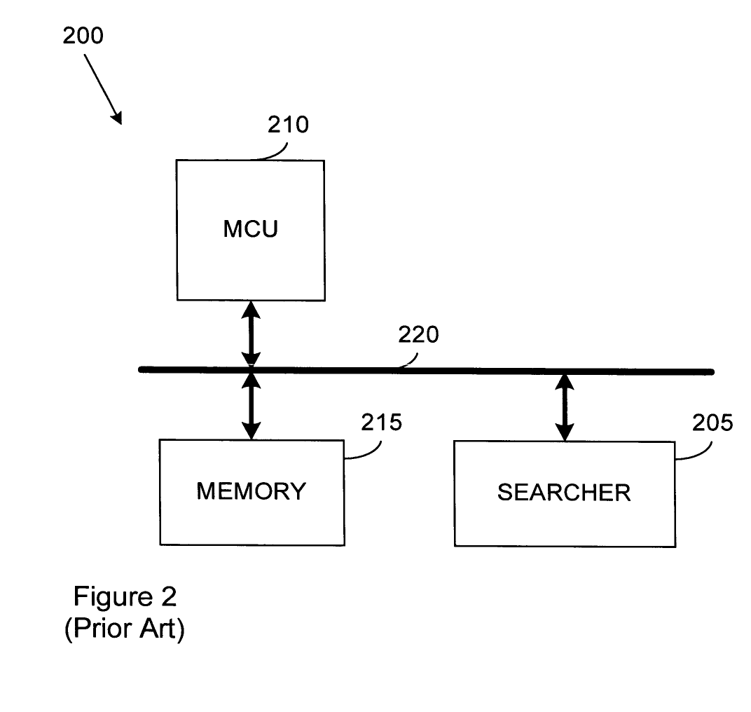

With reference now to FIG. 2, there is shown a diagram illustrating a portion of a wireless device 200 with a prior art searcher 205. The searcher 205, as illustrated in FIG. 2, may be a serial or parallel searcher with one or more correlators (not shown) that can be used to correlate a received signal (usually in the form of two quadrature mode sequences, I and Q) with locally generated versions of the received sequences. A mobile control unit (MCU) 210 can program specific hypotheses that it wishes the searcher 205 to test. Depending on implementation, the MCU 210 can program the searcher 205 by writing the hypotheses to a memory 215 or by writing directly to the searcher 205. When the searcher 205 completes a correlation, the searcher 205 can notify the MCU 210 that is has completed the correlation by asserting an interrupt. Upon receipt of the interrupt, the MCU 210 may process the results of the correlation and/or provide more hypotheses for the searcher 205 to correlate. Note that the MCU 210 may provide the searcher 205 with a single hypothesis at a time (if the searcher 205 is a serial searcher with a single correlator) or with a plurality of hypotheses (if the searcher 205 is a parallel searcher). A communications bus 220 can be used to connect the searcher 205 to the MCU 210 and to the memory 215.

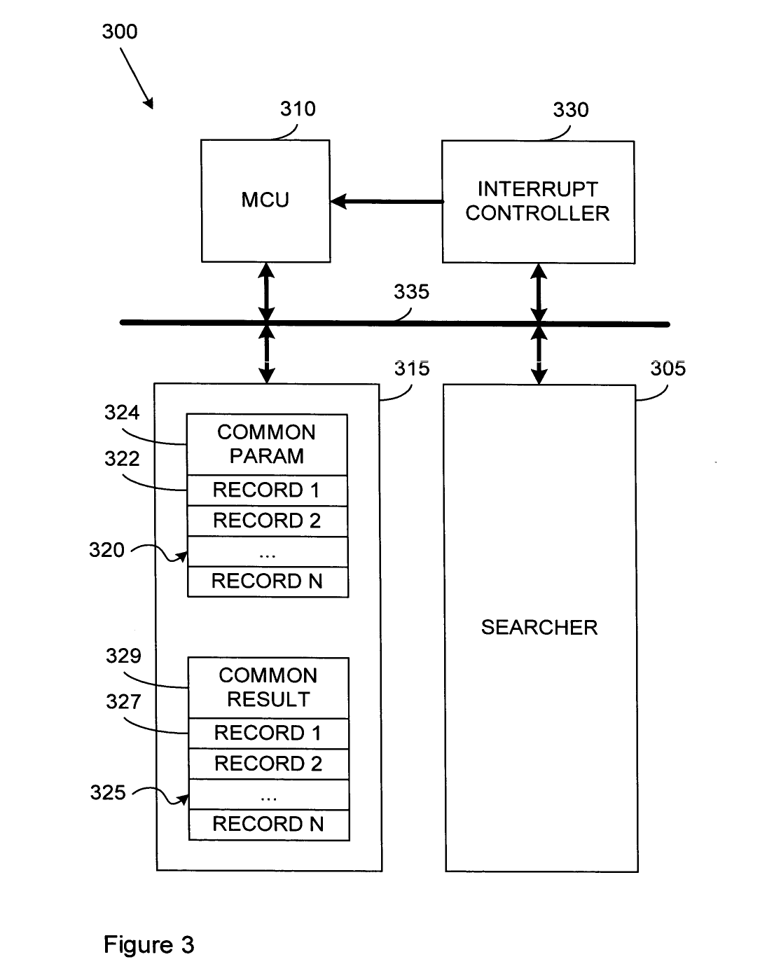

With reference now to FIG. 3, there is shown a diagram illustrating a portion of a wireless device 300 wherein a searcher 305 can make use of batched processing of hypotheses to improve searcher throughput, according to a preferred embodiment of the present invention. The searcher 305, as illustrated in FIG. 3, may be a parallel searcher with a plurality of correlators. The searcher 305 can be used to correlate a received sequence with a plurality of locally generated versions of the received sequence, with each correlation occurring with a different locally generated received sequence based upon hypotheses provided by an MCU 310.

Unlike the case of the wireless device 200 displayed in FIG. 2, wherein the MCU 210 may be able to provide only a single hypothesis or a plurality of dependent hypotheses (hypotheses whose PN offsets are basically adjacent to each other in PN space and differ from one another by a fixed amount of PN offset), the MCU 310 may be able to provide a large number of hypotheses that may be independent of one another. Alternatively, the MCU 310 may be able to provide multiple groups of hypotheses, wherein the hypotheses within a single group may be dependent but the groups themselves are independent. For example, the MCU 310 may provide to the searcher 305 a plurality of groups of hypotheses, where each group may specify a window of particular size and location at different places in the PN space. The searcher 305 can then search using generated PN sequences from hypotheses in each group (or a plurality of groups), with the number depending upon the availability of correlators in the searcher 305. For example, if each group of hypotheses contains 64 hypotheses and the searcher 305 has a total of 256 correlators, then it can be possible to have the searcher 305 correlate the hypotheses from up to four (4) groups of hypotheses at one time.

The MCU 310 may specify the groups of hypotheses by writing each group (or each hypothesis if each hypothesis is independent) into a memory 315. Note that if a hypothesis being specified by the MCU 310 is fully independent, with no commonality with other hypotheses, then it may need to be kept apart from the other hypotheses. In this case, the single hypothesis would essentially be a group of one hypothesis. According to a preferred embodiment of the present invention, if the MCU 310 is specifying a group of hypotheses, the hypotheses within the group should be related to one another. For example, a group of hypotheses may be used to specify a search window of a certain size and a certain search resolution and beginning at a certain PN offset. Another group of hypotheses may be used to specify a search for a base station by specifying a specific scrambling code while a different group may specify a search with a different search resolution or dwell length, and so forth.

The memory 315 may be partitioned into a parameters memory 320 and a results memory 325. The parameters memory 320 may be used to store the groups of hypotheses specified by the MCU 310. Each hypothesis or group of hypotheses can be stored in a partition of the parameters memory 320 referred to as a record (such as record #1 322). The record can be used to store all of the relevant information needed to specify a group of hypotheses, such as PN offset, Walsh code, search resolution, dwell time, scrambling code, and so forth. To save storage space, the parameters memory 320 may include a common parameters partition 324. The common parameters partition 324 can be used to store any hypothesis parameters that may be in common across all groups of hypotheses stored in the parameters partition 320.

As they are written to the parameters partition 320, each group of hypotheses can be assigned a reference number that can be used for future reference to each group. For example, a group written to record #1 322 may be assigned a reference number one (1). This reference number can then be used to read the parameters for the group from the parameters partition 320.

After a group of hypotheses is read from the parameters partition 320 and the searcher 305 performs a search using the hypotheses, the results of the search can be written back to the memory 315. The results of the search can be stored (using the reference number assigned to the group of hypotheses) in the results partition 325. For example, results from the search performed using the group of hypotheses stored in parameters partition record #1 322 can be stored in results partition record #1 327.

According to a preferred embodiment of the present invention, there are eight (8) records in each of the parameters partition 320 and the results partition 325. Note that the number of records in the partitions can be dependent upon the amount of memory available in the wireless device 300 and that there is no restriction on the number of records in the partitions due to the present invention. Other equally valid number of records can basically be any positive integer number, such as four (4), six (6), nine (9), 12, 16, 20, 23, 26, 27, 32, and so forth. A large number of records can allow the MCU 310 to specify a large number of hypotheses while eliminating the need for the MCU 310 to have to specify more hypotheses for an extended period of time.

According to a preferred embodiment of the present invention, the searcher 305 can notify the MCU 310 of its completion of a search through the assertion of an interrupt. An interrupt controller 330 can be used to process and filter the interrupts to the MCU 310. The MCU 310 can specify to the searcher 305 after what operation it wishes to be interrupted. For example, the MCU 310 may desire a low number of interrupts and request that the searcher 305 not interrupt it until the searcher 305 has completed a certain number of the groups of hypotheses. Alternatively, the MCU 310 may request that the searcher 305 interrupt it after each group of hypotheses is complete.

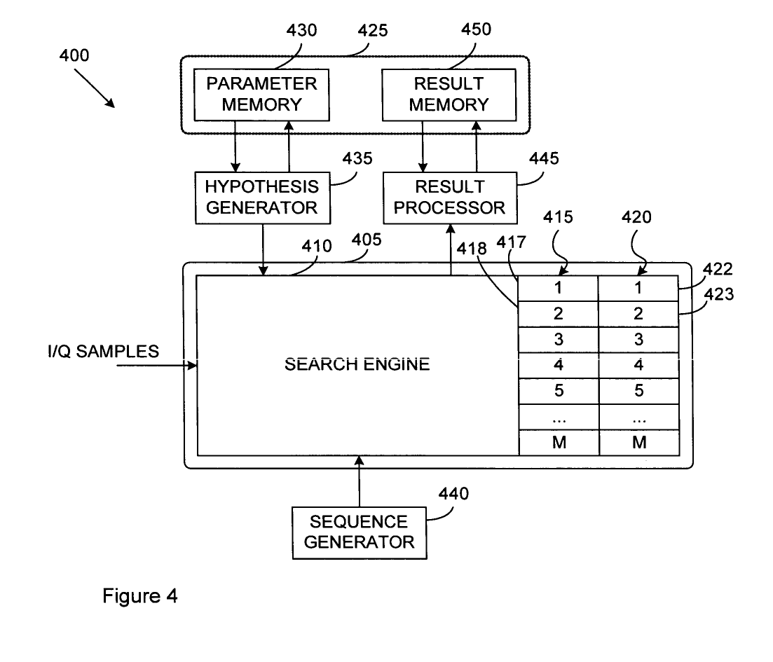

With reference now to FIG. 4, there is shown a diagram illustrating a view of a searcher 405 and attendant hardware, wherein the searcher 405 is capable of using batched processing of hypotheses to improve its throughput, according to a preferred embodiment of the present invention. The searcher 405 can be divided into three parts: a search engine 410, a control information storage 415, and a scratch memory 420. The search engine 410 performs the actual work of a searcher, such as correlation and accumulation (coherent and non-coherent). As discussed previously, the searcher 405 may have multiple correlators, each capable of correlating a receive sequence (provided through an input labeled “I/Q Samples”) with a locally generated PN sequence which can be based upon a hypothesis provided by an MCU (not shown). According to a preferred embodiment of the present invention, the searcher 405 has 256 correlators, each capable of operating independently. Note that the number of correlators, 256 in this case, is typically a design decision and is not a restriction of the present invention.

The control information storage 415 can be used to store control information for the correlators. According to a preferred embodiment of the present invention, since the correlators are independent, there can be a control information storage space dedicated to each one of the correlators, (such as storage space #1 417 and storage space #2 418). For example, if there are 256 correlators, then there will be 256 control information storage spaces. The scratch memory 420 can be used to store intermediate results, the locally generated PN sequences, and so forth for use by the correlators. Once again, since the correlators are independent, there should be a scratch memory storage space for each of the correlators (such as scratch memory #1 422 and scratch memory #2 423). The number of control information storage spaces should match the number of scratch memory storage spaces.

The hypotheses, as provided by a MCU (not shown), can be stored in a parameter memory 430 of a memory 425. The memory 425 can also have a results memory 450 where the results from the testing of the hypotheses can be stored. Note that while the parameter memory 430 and the results memory 450 are displayed as being part of a larger memory, the parameter and result memories 430 and 450 may be separate memories.

Coupled to the parameter memory 430 can be a hypothesis generator 435. According to a preferred embodiment of the present invention, the hypothesis generator 435 can make use of the parameters stored in the parameter memory 430 and a timing reference to generate actual hypotheses, which can be provided to the searcher 405. The hypotheses provided by the hypothesis generator 435 can then be provided to a sequence generator 440 where PN sequences can be generated. The PN sequences generated by the sequence generator 440 can be provided to the correlators in the searcher 405 where they can be correlated against the received sequence. While the correlation takes place, control information storage 415 and scratch memory 420 can be used.

When the testing of a group of hypotheses is complete, the results of the correlations can be provided to a result processor 445. According to a preferred embodiment of the present invention, the result processor 445 may compare the resulting accumulations calculated from the testing of the hypotheses against a prespecified threshold. The accumulations which exceed the prespecified threshold can be saved in the result memory 450, while those that do not may be discarded. Alternatively, all of the accumulation results may be stored in the result memory 450.

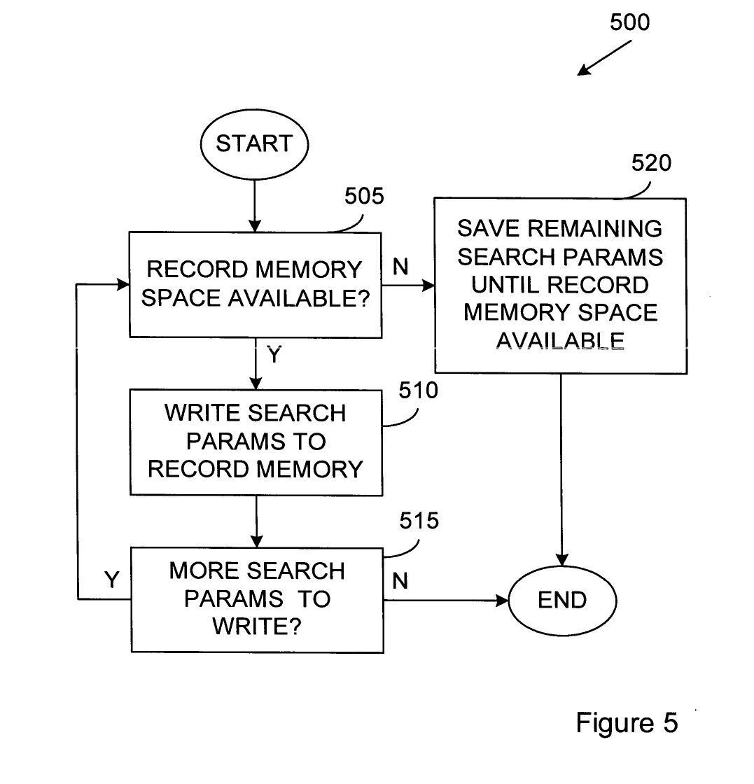

With reference now to FIG. 5, there is shown a diagram illustrating an algorithm 500 for writing search parameters to record memory, according to a preferred embodiment of the present invention. According to a preferred embodiment of the present invention, the algorithm 500 should execute on a MCU (such as the MCU 310 (FIG. 3)). Alternatively, the algorithm 500 may execute on a digital signal processor (DSP), a generic micro-processor, a central processing unit, a micro-controller, or a custom designed integrated circuit (ASIC) that can be used to provide control or processing capabilities to a wireless device.

The MCU 310 may begin when it has hypotheses that it desires to be searched. This may occur at system power-up (system synchronization, for example) or periodically during normal operations, when the MCU 310 desires to maintain and update its neighbor set (to be used for cell hand-offs, for example) or if the MCU 310 wishes to characterize the communications channel so that it can update its rake receiver fingers to maximize the received signal. The MCU 310 can first check to see if there is any available storage space in the record memory (block 505). If there is storage space, then the MCU 310 can write a set of search parameters corresponding to one group of hypotheses to the record memory (block 510). As discussed previously, hypotheses in the group of hypotheses written to the record memory should be related to one another in some way and should not simply be randomly collected independent hypotheses. Alternatively, the MCU 310 may write a set of parameters for a single hypothesis, if there are no other hypotheses that are related to the hypothesis being written.

After writing a set of search parameters corresponding to a group of hypotheses to the record memory (block 510), the MCU 310 can check to see if it has any additional sets of search parameters to write to record memory (block 515). If there are additional sets of search parameters, the MCU 310 can return to block 505, where it will check to see if there is sufficient storage for another set of search parameters. If the MCU 310 has no more sets of search parameters to write, then the algorithm 500 can terminate. If record memory has no more storage space (block 505), then the MCU 310 can save its remaining sets of search parameters and wait for a later time, when there is storage space in record memory (block 520).

According to a preferred embodiment of the present invention, the MCU 310, after saving its unwritten sets of search parameters, can return to performing its other tasks. Then, when the MCU 310 receives an interrupt, perhaps from a searcher to notify the MCU 310 of the completion of a set of search parameters or a plurality of sets of search parameters (depending on specifications provided by the MCU 310), the MCU 310 can check for available storage space in record memory (block 505, for example) and if space is available, then the MCU 310 can write at least some of the sets of search parameters to record memory.

According to another preferred embodiment of the present invention, the MCU 310 may, in a single step, determine the amount of available storage space in the record memory and write a corresponding number of sets of search parameters to record memory. This method of writing the sets of search parameters to record memory can reduce interactions between MCU 310 and the record memory.

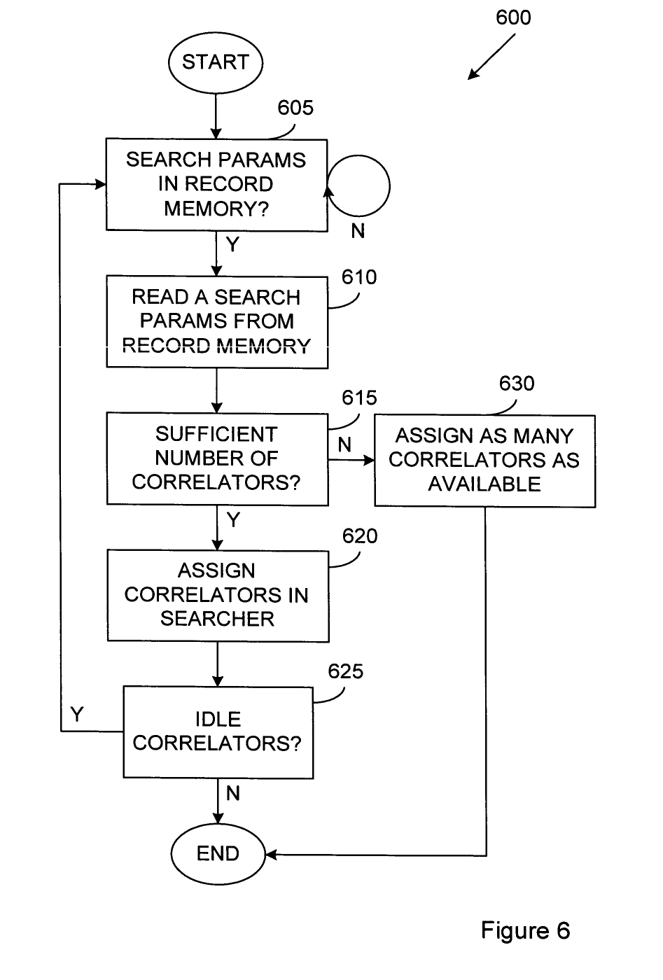

With reference now to FIG. 6, there is shown a diagram illustrating an algorithm 600 for using sets of search parameters written to record memory to test hypotheses via batch processing, according to a preferred embodiment of the present invention. According to a preferred embodiment of the present invention, the algorithm 600 may execute on a controller used to control the operation of a searcher (such as the searcher 405 (FIG. 4)). The algorithm 600 may be implemented in the firmware of the controller. Alternatively, the algorithm 600 may be implemented in the searcher 405 itself.

The controller can begin by determining the status of the record memory (block 605). If the record memory is empty, the searcher 405 has no hypotheses to test, so it can remain idle. If there are search parameters in the record memory, then a first set of search parameters can be read from the record memory (block 610). Then, based on the search parameters, the controller can check to see if the searcher 405 has a sufficient number of correlators to process the hypotheses (block 615).

If the searcher 405 has an adequate number of correlators, then the controller can assign as many correlators as needed to begin correlating the hypotheses with a received sequence (block 620). After assigning all of the hypotheses to correlators, the controller can check to see if there are any idle correlators (block 625). If there are no more idle correlators, then the algorithm 600 may terminate to begin once again when correlators become freed. If there are idle correlators, the controller can return to block 605 to see if there are additional search parameters to process.

If in block 615, there were not as many free correlators as there are hypotheses to process, the controller may elect to assign as many hypotheses as there are free correlators (block 630). Alternatively, the controller may choose to not assign any of the hypotheses, since doing so can break up a group of hypotheses, resulting in some hypotheses completing before other hypotheses within a same group of hypotheses.

According to another preferred embodiment of the present invention, after the controller has assigned correlators to begin correlating the hypotheses specified by a set of search parameters (block 620), the controller can the determine the number of idle correlators remaining in the searcher (block 625) and then the controller can return to record memory (blocks 605 and 610) to select a set of search parameters which specify a number of hypotheses that best fits the number of idle correlators. By attempting to select the set of search parameters specifying a number of hypotheses that best matches the number of available correlators, the controller can attempt to optimize the usage of the searcher's correlators.

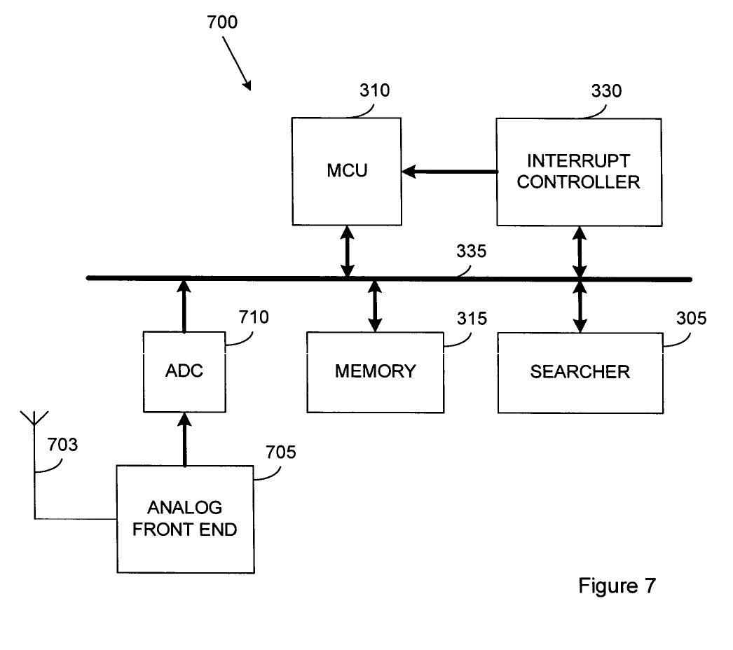

With reference now to FIG. 7, there is shown a block diagram illustrating a wireless device 700 with a searcher 305 with the capability of using batched processing of independent parameters to improve searcher throughput, according to a preferred embodiment of the present invention. The wireless device 700 includes an analog front end 705 which receives signals received over-the-air by an antenna 703. The analog front end 705 may be used to filter the received signal to help eliminate out-of band noise and interference, equalize and amplify the received signal to bring the received signal to a power level that is suitable for processing, and so forth. An analog-to-digital converter (ADC) 710 converts the analog signal into its digital representation.

Digital symbols, as produced by the ADC 710, may then be provided to a mobile control unit (MCU) 310. The MCU 310 can be responsible for functions such as controlling the operation of the wireless device, regulating the movement of data, and so on. Coupled to the MCU 310 via a communications bus 335 can be a searcher 305 and a memory 315. The searcher 305 can be used to help the wireless device 700 become synchronized with base stations in rapid fashion. The memory 315 can be used to store sets of search parameters and results from the searcher 305 testing hypotheses specified by the differing sets of search parameters. Additionally, a digital signal processor (DSP) (not shown) or a generic processing element may be available to perform many of computationally intensive tasks, such as error detecting and correcting, data decoding, filtering, and so forth. In some implementations, the DSP and the MCU 310 may be the same entity.

An interrupt controller 330 can be used to filter incoming interrupts to the MCU 310. For example, depending on how it is configured, the searcher 305 may assert an interrupt to the MCU 310 each time it completes the testing of a group of hypotheses specified by a set of search parameters. Alternatively, the searcher 305 may be configured to assert an interrupt after it has completed the testing of several groups of hypotheses (for example, several groups of hypotheses designed to acquire the pilot channels of base stations in a neighbor set). In addition to interrupts from the searcher 305, the MCU 310 may receive interrupts from other circuits to which it may be coupled. The interrupt controller 330 can be used to filter and perhaps prioritize the interrupts to help the MCU 310 process the interrupts in an intelligent and efficient manner.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for detecting signals comprising:
reading a set of search parameters;
generating a group of hypotheses from the set of search parameters;
assigning each hypothesis from the group to a correlator;
correlating a pseudo-random number (PN) sequence generated from each hypothesis against a received sequence;
accumulating the correlation result; and
processing the accumulation result.

2. The method of claim 1, wherein the set of search parameters is stored in a record memory.

3. The method of claim 2, wherein there are a plurality of sets of search parameters stored in the record memory, and wherein each set of search parameters is assigned a reference number.

4. The method of claim 3, wherein there is a result memory, and wherein results from the processing are stored in the result memory with the same reference number as the set of search parameters.

5. The method of claim 1 further comprising prior to the reading:
determining availability of storage space; and
writing the set of search parameters by a control unit if storage space is available.

6. The method of claim 5 further comprising repeating the determining and the writing until storage space is no longer available or all sets of search parameters have been written.

7. The method of claim 1 wherein the assigning comprises:
assigning each hypothesis from the group to a correlator if there are as many idle correlators as there are hypotheses in the group; and
assigning as many hypotheses as there are idle correlators, wherein each hypothesis is assigned to a correlator, if there are fewer idle correlators than hypotheses.

8. The method of claim 1, wherein there are a plurality of sets of search parameters, and wherein the assigning comprises:
determining if there are a sufficient number of correlators; and
repeating the reading, generating, and assigning with a different set of search parameters if there is an insufficient number of correlators.

9. The method of claim 1 further comprising repeating the reading, generating, and assigning as long as there are idle correlators.

10. The method of claim 1 further comprising storing the results from the processing.

11. The method of claim 10, wherein the set of search parameters is assigned a reference number, and wherein the results of the processing is stored using the same reference number as the set of search parameters.

12. The method of claim 1, wherein the set of search parameters specifies a single hypothesis, and wherein the group of hypotheses contains the single hypothesis.

13. A circuit comprising:
a memory to store sets of search parameters and search results, wherein each set of search parameters is assigned a reference number, and a set of search results for a set of search parameters is stored with the same reference number;
a searcher coupled to the memory, the searcher containing circuitry to read a set of search parameters from the memory, process pseudo-random number (PN) sequences generated based the set of search parameters with a received sequence, and write the correlation results to a set of search results with the reference number of the set of search parameters; and
a sequence generator coupled to the searcher, the sequence generator containing circuitry to generate a PN sequence from each hypothesis provided to it by the searcher.

14. The circuit of claim 13, wherein the memory further comprises:
a common parameter storage space to store search parameters common to each set of search parameters currently in the memory; and
a common result storage space to store search results common to each search result currently in the memory.

15. The circuit of claim 13 further comprising:
a hypothesis generator coupled to the memory and the search engine, the hypothesis generator containing circuitry to generate hypotheses from the set of search parameters and from a timing reference provided by the searcher; and
a result processor coupled to the search engine and the memory, the result processor containing circuitry to compare the set of search results against a specified threshold.

16. The circuit of claim 13, wherein the searcher comprises:
a plurality of correlators to correlate a received sequence with each of the generated PN sequences;
a control memory to store control information for use in the processing of the generated PN sequences; and
a scratch memory to store temporary results during the processing.

17. The circuit of claim 16, wherein the control memory and the scratch memory are partitioned into a plurality of storage spaces, and wherein there is a control memory storage space and a scratch memory storage space for each correlator.

18. The circuit of claim 13, wherein the memory can store eight (8) sets of search parameters, eight (8) sets of search results, and wherein the searcher has 256 correlators.

19. A wireless device comprising:
an analog front end coupled to an antenna, the analog front end containing circuitry to filter and amplify a received signal provided by the antenna;
an analog-to-digital converter (ADC), the ADC to convert an analog signal provided by the analog front end into a digital symbol stream; and
a processing unit coupled to the ADC, the processing unit containing circuitry to store sets of search parameters and search results, test hypotheses derived from the sets of search parameters.

20. The wireless device of claim 19, wherein the processing unit comprises:
a memory to store sets of search parameters and search results, wherein each set of search parameters is assigned a reference number, and a set of search results for a set of search parameters is stored with the same reference number;
a controller coupled to the memory, the controller to write sets of search parameters to the memory and retrieve sets of search results from the memory; and
a searcher coupled to the memory and the controller, the searcher containing circuitry to read a set of search parameters from the memory, create hypotheses from the set of search parameters, correlate the hypotheses with a received sequence, and write the correlation results to a set of search results with the reference number of the set of search parameters.

21. The wireless device of claim 20, wherein the memory further comprises:
a common parameter storage space to store search parameters common to each set of search parameters currently in the memory; and
a common result storage space to store search results common to each search result currently in the memory.

22. The wireless device of claim 20, wherein the searcher comprises a plurality of correlators, wherein a set of search parameters can result in a plurality of hypotheses, and wherein each hypothesis from the plurality of hypotheses is assigned to a unique correlator.

23. The wireless device of claim 22, wherein each assigned correlator correlates a pseudo-random number (PN) sequence generated from its hypothesis with a received sequence.

24. The wireless device of claim 23, wherein each assigned correlator correlates with the same received sequence.

25. The wireless device of claim 20, wherein the controller also specifies when the searcher may assert an interrupt to notify the controller that the searcher has completed processing an assigned search.

26. The wireless device of claim 19, wherein the wireless device operates in a digital communications network.

27. The wireless device of claim 26, wherein the digital communications network is a direct sequence spread spectrum communications network.

28. The wireless device of claim 27, wherein the digital communications network is a CDMA2000 compliant communications network.

29. The wireless device of claim 27, wherein the digital communications network is a Universal Mobile Telephony System (UMTS) compliant communications network.

30. The wireless device of claim 26, wherein the wireless device is capable of operating in a plurality of digital communications networks.
